(19) United States
(12) Patent Application Publication
(10) Pub. No.: US 2009/0004517 A1
(43) Pub. Date: Jan. 1, 2009

(54) FUEL CELL DEVICE AND DRIVING METHOD THEREFOR

(75) Inventors: Terumasa NAGASAKI, Tokyo (JP); Tomohiro HIRAYAMA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/163,847

(22) Filed: Jun. 27, 2008

(30) Foreign Application Priority Data
Jun. 29, 2007 (JP) 2007-173370

(51) Int. Cl. H01M 8/04

(52) U.S. Cl. 429/23; 429/14

(57) ABSTRACT

According to an embodiment, a fuel cell device includes an electromotive section which has an anode and a cathode and generates electricity, a tank, a fuel channel through which fuel supplied from the tank is run via the anode side of the electromotive section, a flow regulator section which adjusts a flow rate of the fuel supplied to the anode, a sensor which detects an amount of the fuel in the tank, and a cell control section. The cell control section causes the flow regulator section to adjust the fuel flow rate to an upper limit value of an adjustable range when an increase in the amount of fuel in the tank is detected by the sensor and to adjust the fuel flow rate to a minimum necessary flow rate for an electricity generation operation when a reduction of the amount of fuel in the tank is detected.

### CROSS-REFERENCE TO RELATED APPLICATIONS

This application is based upon and claims the benefit of priority from Japanese Patent Application No. 2007-173370, filed Jun. 29, 2007, the entire contents of which are incorporated herein by reference.

### BACKGROUND

1. Field

One embodiment of the present invention relates to a fuel cell device for supplying a current to an electronic device or the like.

2. Description of the Related Art

Presently, secondary batteries, such as lithium ion batteries, are mainly used as energy sources for portable notebook personal computers (notebook PCs), mobile devices, etc. In recent years, small, high-output fuel cells that require no charging have been expected as new energy sources to meet the demands for increased energy consumption and prolonged use of these electronic devices with higher functions. Among various types of fuel cells, direct methanol fuel cells (DMFCs) that use a methanol solution as their fuel, in particular, enable easier handling of the fuel and a simpler system configuration, as compared with fuel cells that use hydrogen as their fuel. Thus, the DMFCs are noticeable energy sources for the electronic devices.

Usually, a DMFC is provided with a fuel tank that contains methanol, a liquid pump that force-feeds the methanol to an electromotive section, an air pump that supplies air to the electromotive section, etc. The electromotive section is provided with a cell stack composed of laminated single cells, each including an anode and a cathode. As the methanol and air are supplied to the anode and cathode sides, respectively, electricity is generated by a chemical reaction. As reaction products that are produced by the electricity generation, unreacted methanol and carbon dioxide are generated on the anode side of the electromotive section, and water on the cathode side. The water as a reaction product is reduced to steam and discharged.

The fuel cell constructed in this manner has been developed as a cell that ensures a clean exhaust gas. In case of a system abnormality, unreacted methanol, excessive carbon dioxide, or intermediate products, such as formic acid, formaldehyde, etc., may possibly be discharged. Therefore, the fuel cell is operated in such a manner that its generated electricity and the temperature of the cell stack are measured as it performs optimum fuel supply and temperature control lest the exhaust gas be discharged in excess of a prescribed level. Proposed in, for example, Jpn. Pat. Appln. KOKAI Publication No. 2006-331907 is a fuel cell device that is provided with a gas sensor for detecting a reducing gas on the exhaust side such that an operation is stopped when a harmful exhaust gas is detected by the sensor.

According to the fuel cell constructed in this manner, the operation of the fuel cell can be improved in reliability by detecting the exhaust gas by means of the sensor. Depending on operating conditions of the fuel cell, however, the aforesaid fuel supply control, based on the result of detection of the exhaust gas, cannot easily maintain optimum running conditions and output energy of the fuel cell.

Thus, if an aqueous methanol solution is used as an anode fuel, the cell stack can be assured of a high energy output by increasing the fuel flow rate or fuel concentration. On the other hand, the methanol crossover rate that is associated with increases in heat release and fuel consumption rates considerably increases if the fuel concentration is increased, while it changes little when the flow rate changes.

In order to obtain the output energy efficiently from the cell stack, therefore, it is effective to increase the flow rate of the anode fuel. If the fuel is supplied by using a liquid pump or the like, however, the increase in the fuel flow rate results in increases in the energy consumption and noise of the pump.

In the case of a water-irrecoverable DMFC in which water is not recovered on the cathode side of a cell stack, the rate of water permeation from an anode to a cathode through an electrolyte membrane is an important factor, as well as the aforementioned output energy and methanol crossover rate. However, the water permeation rate tends to increase if the fuel flow rate is increased. If the anode fuel flow rate is increased in order to obtain a higher energy output, in the water-irrecoverable DMFC, therefore, a liquid amount in an anode system is reduced as the water permeation rate increases, thereby possibly hindering the operation. Accordingly, the fuel flow rate must be adjusted in accordance with the liquid amount in the anode system as well as the output energy.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram schematically showing a fuel cell device according to a first embodiment of the invention;

FIG. 2 is an exemplary view schematically showing a single cell constituting a cell stack of the fuel cell device;

FIG. 3 is an exemplary diagram showing relationships between the fuel flow rate, fuel concentration, and output energy of the fuel cell device;

FIG. 4 is an exemplary diagram showing relationships between the fuel flow rate, fuel concentration, and methanol crossover rate of the fuel cell device;

FIG. 5 is an exemplary diagram showing relationships between the fuel flow rate, fuel concentration, and water permeation rate of the fuel cell device;

FIG. 6 is an exemplary flowchart showing an optimization operation for the fuel flow rate based on a liquid amount and the output energy; and

FIG. 7 is an exemplary diagram schematically showing a fuel cell device according to a second embodiment of the invention.

### DETAILED DESCRIPTION

Embodiments of this invention will now be described in detail with reference to the accompanying drawings. In general, according to an embodiment of the invention, a fuel cell device comprises an electromotive section which includes an anode and a cathode and generates electricity based on a chemical reaction between a fuel supplied to the anode and air supplied to the cathode; a tank configured to store contains the fuel; a fuel channel through which the fuel supplied from the tank is run via the anode side of the electromotive section; a flow regulator section which adjusts a flow rate of the fuel supplied to the anode; a sensor which detects an amount of the fuel in the tank; and a cell control section which causes the flow regulator section to adjust the fuel flow rate to an upper limit value of an adjustable range when an increase in the amount of fuel in the tank is detected based on the result of the detection by the sensor and to adjust the fuel flow rate to a minimum necessary flow rate for an electricity generation operation of the electromotive section when a reduction of the amount of fuel in the tank is detected.

FIG. 1 schematically shows a fuel cell device 10 according to a first embodiment of the invention. As shown in FIG. 1, the fuel cell device 10 is constructed as a DMFC that uses methanol as its liquid fuel. The device 10 is constructed as a DMFC that uses methanol as its liquid fuel. The fuel cell device 10 is provided with a cell stack 12, a fuel tank 14, a circulation system 20, and a cell control section 16. The cell stack 12 constitutes an electromotive section. The circulation system 20 supplies the fuel and air to the cell stack. The cell control section 16 controls the operation of the entire fuel cell device. The cell control section 16 includes a microcomputer (CPU) and the like and is electrically connected to the cell stack 12. Further, the cell control section 16 supplies electricity generated in the cell stack 12 to an electronic device 17, such as a notebook PC, and measures output energy.

The fuel tank 14 has a sealed structure in which high-concentration methanol is contained. The tank 14 may be formed as a fuel cartridge that is removably attached to the fuel cell device 10.

The circulation system 20 includes an anode channel (fuel channel) 22, a cathode channel (gas channel) 24, and a plurality of ancillary components. The fuel that is supplied from a fuel outlet of the fuel tank 14 is run through the anode channel 22 via the cell stack 12. A gas that contains air is circulated through the cathode channel 24 via the cell stack 12. The ancillary components are incorporated in the anode and cathode channels. The anode and cathode channels 22 and 24 are each formed of piping or the like.

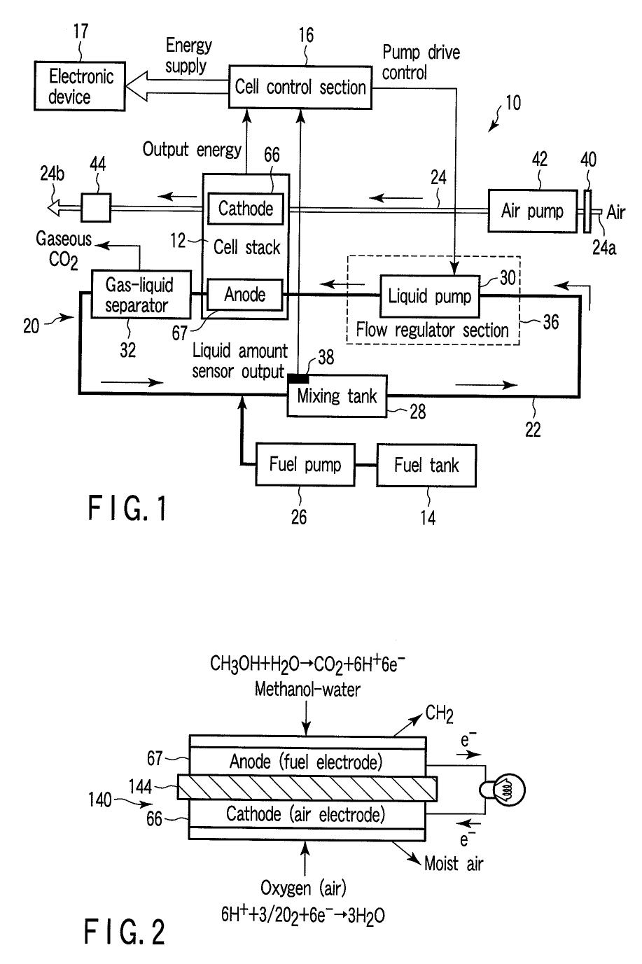

The cell stack 12 is formed by stacking a plurality of single cells in layers. FIG. 2 typically shows an electricity generation reaction of each single cell. Each single cell 140 is provided with a membrane electrode assembly (MEA), which integrally includes a cathode (air electrode) 66, an anode (fuel electrode) 67, and a substantially rectangular polymer electrolyte membrane 144. The cathode 66 and the anode 67 are substantially rectangular plates that are each formed of a catalyst layer and a carbon paper. The polymer electrolyte membrane 144 is sandwiched between the cathode and the anode. The polymer electrolyte membrane 144 is larger in area than the anode 67 and the cathode 66.

The supplied fuel and air chemically react with each other in the polymer electrolyte membrane 144 that are interposed between the anode 67 and the cathode 66, whereupon electricity is generated between the anode and the cathode. The electricity generated in the cell stack 12 is supplied to the electronic device 17 through the cell control section 16.

As shown in FIG. 1, the ancillary components provided at the anode channel 22 include on-off valves (not shown) pipe-connected to the fuel outlet of the fuel tank 14, a fuel pump 26, and a mixing tank 28 connected to the output portion of the fuel pump by piping. The ancillary components further include a liquid pump 30 connected to the output portion of the mixing tank 28. The output portion of the liquid pump 30 is connected to the anode 67 of the cell stack 12 through the anode channel 22. Thus, the liquid pump 30 supplies an aqueous methanol solution from the mixing tank 28 to the anode 67.

The mixing tank 28 is fitted with a liquid amount sensor 38 for detecting the amount of a water-methanol mixture, that is, the aqueous methanol solution, in the mixing tank. The sensor 38 is electrically connected to the cell control section 16. The liquid amount sensor 38 detects whether or not the liquid amount in the mixing tank 28 is inappropriate and outputs detection data to the cell control section 16. The drive voltage or rate of rotation of the liquid pump 30 is controlled by the cell control section 16, whereby the flow rate of the fuel supplied to the anode 67 is adjusted. Thus, the liquid pump 30 and the cell control section 16 constitute a flow regulator section 36 for adjusting the fuel flow rate.

The output portion of the anode 67 of the cell stack 12 is connected to the input portion of the mixing tank 28 by the anode channel 22. A gas-liquid separator 32 is incorporated in that part of the anode channel 22 which is situated between the output portion of the cell stack 12 and the mixing tank 28. An exhaust fluid that is discharged from the anode 67 of the cell stack 12, that is, a gas-liquid two-phase flow containing an unreacted portion of the aqueous methanol solution that is not used for the chemical reaction and generated carbon dioxide (CO₂), is fed to the gas-liquid separator 32, in which the carbon dioxide is separated. The separated aqueous methanol solution is returned to the mixing tank 28 through the anode channel 22 and supplied again to the anode 67. The carbon dioxide separated from the gas-liquid separator 32 is discharged to the open air through a filter (not shown).

An intake port 24a and an exhaust port 24b of the cathode channel 24 individually open into the atmosphere. The ancillary components provided at the cathode channel 24 include an air filter 40, an air pump 42, and an exhaust filter 44. The air filter 40 is located near the intake port 24a of the cathode channel 24 on the upstream side of the cell stack 12. The air pump 42 is connected to that part of the cathode channel 24 which is situated between the cell stack 12 and the air filter. The exhaust filter 44 is disposed between the cell stack 12 and the exhaust port 24b on the downstream side of the cell stack.

When the air pump 42 is actuated, air is fed to the cathode channel 24 through the intake port 24a. After the fed air passes through the air filter 40, it is fed from the air pump 42 to the cathode 66 of the cell stack 12, whereupon oxygen in the air is utilized for generation of electricity. The air discharged from the cathode 66 passes through the cathode channel 24 and the exhaust filter 44 and is discharged into the atmosphere through the exhaust port 24b.

The air filter 40 captures and removes dust in the air drawn into the cathode channel 24 and impurities and harmful substances, such as carbon dioxide, formic acid, fuel gas, methyl formate, formaldehyde, etc. The exhaust filter 44 neutralizes byproducts in the gas that is discharged to the outside through the cathode channel 24 and captures the fuel gas and the like in the exhaust.

In operating the fuel cell device 10 constructed in this manner as an energy source of the electronic device 17, the fuel pump 26, liquid pump 30, and air pump 42 are actuated and the on-off valves are opened under the control of the cell control section 16. Methanol is supplied from the fuel tank 14 to the mixing tank 28 by the fuel pump 26, whereupon it is mixed with water in the fuel pump to form an aqueous methanol solution of a desired concentration. Further, the aqueous methanol solution in the mixing tank 28 is supplied to the anode 67 of the cell stack 12 through the anode channel 22 by the liquid pump 30.

An air pump 42 draws the open air into the cathode channel 24 through its intake port 24a. As the air passes through the air filter 40, it is cleared of dust and impurities. After having passed through the filter 40, the air is supplied to the cathode 66 of the cell stack 12.

The methanol and air supplied to the cell stack 12 undergo an electrochemical reaction in the electrolyte membrane 144 that is disposed between the anode 67 and the cathode 66, whereupon electricity is generated between the anode and the cathode. The electricity generated in the cell stack 12 is supplied to the electronic device 17 through the cell control section 16.

With the progress of the electrochemical reaction, carbon dioxide and water are generated as reaction products on the sides of the anode 67 and the cathode 66, respectively, in the cell stack 12. The carbon dioxide generated on the anode side and the unreacted portion of the aqueous methanol solution that is not used for the chemical reaction are fed to the gas-liquid separator 32 through the anode channel 22, whereupon they are separated from each other. The separated aqueous methanol solution is recovered from the gas-liquid separator 32 into the mixing tank 28 through the anode channel 22 and reused for generation of electricity. The separated carbon dioxide is discharged from the separator 32 into the atmosphere.

Most of the water generated on the cathode 66 side of the cell stack 12 is reduced to steam, which is discharged together with air into the cathode channel 24. The gas containing the discharged air and steam is fed to the exhaust filter 44, whereupon it is cleared of dust and impurities and then discharged to the outside through the exhaust port 24b of the cathode channel 24.

During the electricity generation operation described above, the cell control section 16 monitors the amount of the aqueous methanol solution in the mixing tank 28 detected by the liquid amount sensor 38. Based on the detected amount, the control section 16 controls the flow rate of the fuel to be supplied to the anode 67, thereby optimizing the fuel flow rate and the electricity generation operation.

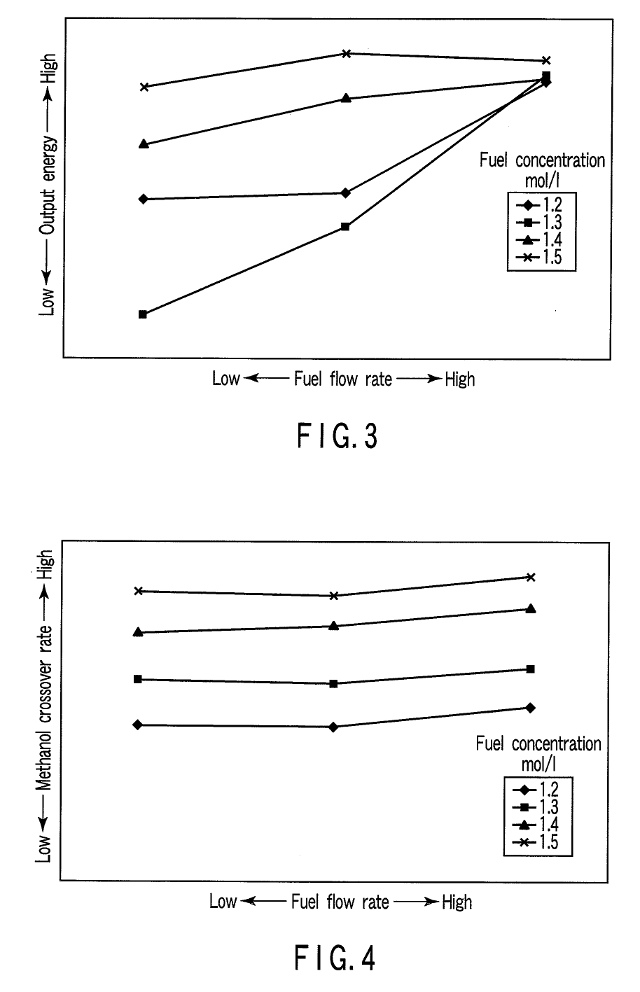

The following is a description of relationships between the output energy and methanol crossover rate of the cell stack 12 and the flow rate and concentration of an anode fuel. FIG. 3 shows the output energy of the cell stack 12 obtained when the flow rate is changed with an aqueous methanol solution of 1.2 to 1.5 mol/l used as the anode fuel. FIG. 4 shows the methanol crossover rate under the same conditions as those shown in FIG. 3.

As seen from FIG. 3, a high energy output can be obtained by increasing the fuel flow rate or the fuel concentration. As shown in FIG. 4, on the other hand, the methanol crossover rate that is associated with increases in heat release and fuel consumption rates considerably increases if the fuel concentration is increased, while it changes little when the flow rate changes.

In order to obtain the output energy efficiently, therefore, it is effective to increase the anode fuel flow rate. If the fuel is supplied by using a liquid pump or the like, however, the increase in the fuel flow rate results in an increase in energy consumption or noise. Therefore, an appropriate fuel flow rate for necessary energy to drive the electronic device 17 that is supplied with electricity from fuel cells is determined depending on a secular output reduction of the cell stack 12 or the like.

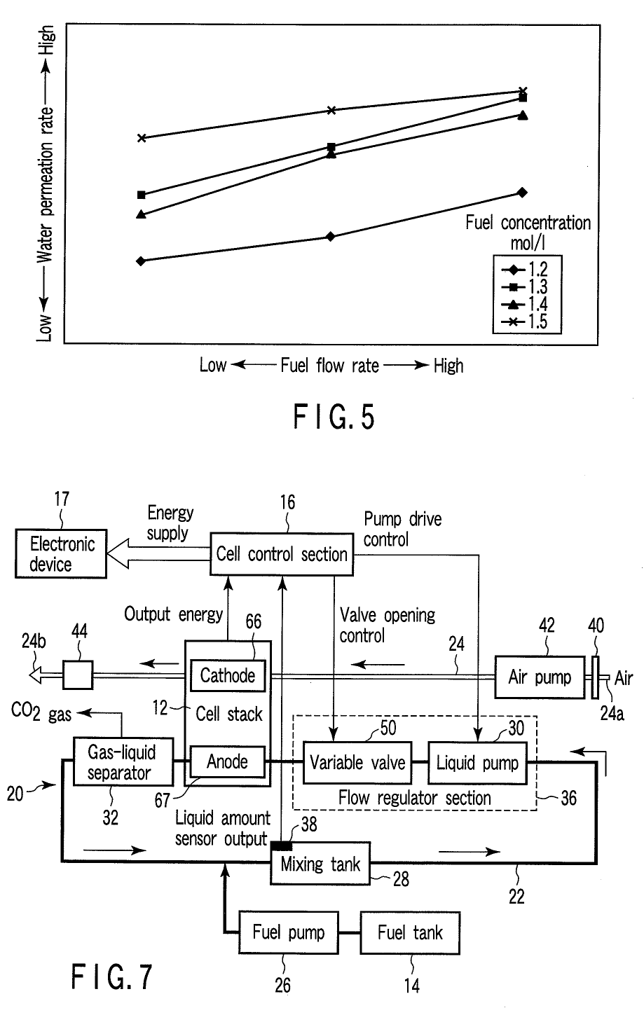

In the case of a water-irrecoverable DMFC, such as the fuel cell device 10 according to the present embodiment, in which water is not recovered by the cathode 66, the rate of water permeation from the anode to the cathode through the electrolyte membrane is an important factor, as well as the aforementioned output energy and methanol crossover rate. The relationship between the water permeation rate of the cell stack 12 and the anode fuel flow rate/concentration will now be described with reference to FIG. 5.

FIG. 5 shows the water permeation rate under the same conditions as those shown in FIGS. 3 and 4. As seen from FIG. 5, the water permeation rate tends to increase if the fuel flow rate is increased. If the anode fuel flow rate is increased in order to obtain a higher energy output, in the water-irrecoverable DMFC, therefore, the liquid amount in the anode channel is reduced as the water permeation rate increases, thereby possibly hindering the electricity generation operation. In the fuel cell device 10 according to the present embodiment, therefore, the fuel flow rate is adjusted to an optimum value in accordance with the liquid amount in the anode channel as well as the output energy.

The following is a description of an example in which the fuel flow rate is optimized with use of the pump drive voltage as a parameter, selected between the pump drive voltage and rate of rotation associated with the fuel flow rate of the liquid pump 30 that is used as means for flow adjustment.

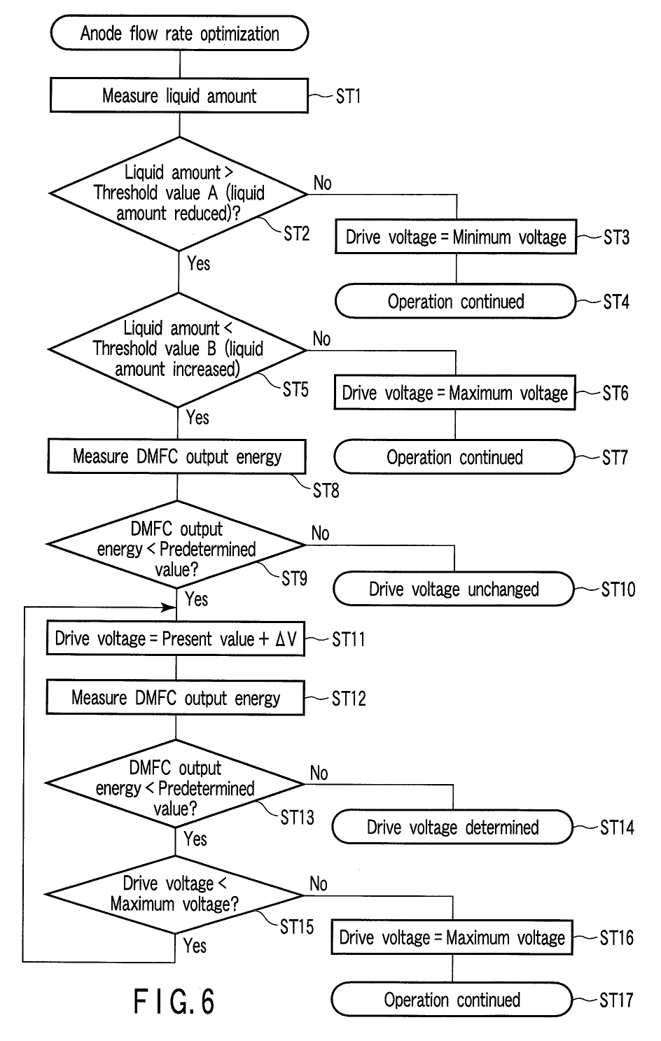

FIG. 6 is a flowchart showing a case where the fuel flow rate is adjusted by changing the drive voltage of the liquid pump. As shown in FIG. 6, the cell control section 16 causes the liquid amount sensor 38 to measure the amount of the aqueous methanol solution in the mixing tank 28 (ST1), and compares the measured liquid amount with a threshold value A for a predetermined liquid amount reduction (ST2). If the measured liquid amount is smaller than the threshold value A, the cell control section 16 changes the drive voltage of the liquid pump 30 to a value (minimum voltage) for a minimum necessary fuel flow rate for the electricity generation operation of the cell stack 12, that is, a lower limit value of an adjustable range for the flow rate in this case, in order to reduce the water permeation rate of the cell stack 12 (ST3). The liquid pump 30 is driven at the minimum drive voltage (ST4), whereby the flow rate for the aqueous methanol solution supply is reduced.

If the measured liquid amount is greater than the threshold value A, on the other hand, the cell control section 16 compares a liquid amount measured by the liquid amount sensor 38 with a threshold value B for a predetermined liquid amount increase (ST5). If the measured liquid amount is greater than the threshold value B, the cell control section 16 changes the drive voltage of the liquid pump 30 to an upper limit value (maximum voltage) of the adjustable range for the flow rate, in order to increase the water permeation rate of the cell stack 12 (ST6). The liquid pump 30 is driven at the maximum drive voltage (ST7), whereby the flow rate for the aqueous methanol solution supply is increased.

If the measured liquid amount is smaller than the threshold value B, that is, if it is intermediate between the threshold values A and B, the cell control section 16 measures the output energy of the cell stack 12 (ST8) and determines whether the output energy is not smaller than a predetermined value (e.g., necessary energy for the fuel cell device to drive the electronic device 17) (ST9). If the output energy is not smaller than the predetermined value, the cell control section 16 continues to operate the fuel cell device without changing the drive voltage (ST10).

If the output energy is smaller than the predetermined value, the cell control section 16 increases the drive voltage of the liquid pump 30 by ΔV, thereby increasing the flow rate of the fuel supplied to the cell stack 12 (ST11). The value ΔV is an optional value based on the resolution of the flow regulator section 36 and the sensitivity of the cell stack output to the fuel flow rate. The cell control section 16 drives the liquid pump 30 at a new drive voltage settled in ST11 and measures the output energy of the cell stack 12 in this state (ST12). The cell control section 16 compares the measured output energy with a predetermined value (ST13). If the predetermined value is exceeded, the operation is continued at the new drive voltage (ST14).

If the output energy is not greater than the predetermined value, the cell control section 16 determines whether or not the upper limit value (maximum voltage) of the adjustable range is reached by the present drive voltage (ST15). If the upper limit value is not reached, the procedure returns to ST11, in which the same processing is repeated so that the output energy of the cell stack 12 reaches the predetermined value. If the upper limit value is reached, the cell control section 16 terminates the processing and continues the operation of the liquid pump 30 at the maximum drive voltage (ST16 and ST17).

According to the fuel cell device 10 constructed in this manner, the flow rate of the fuel supplied to the anode 67 of the cell stack 12 is varied based on the amount of fuel in the mixing tank 28. By doing this, the water permeation rate in the cell stack, as well as the output energy, can be controlled optimally. Further, the output energy can be enhanced by increasing the flow rate of the fuel supplied to the anode in response to a reduction in the output energy without increasing the methanol crossover rate. An appropriate flow rate that ensures necessary electricity for the drive of the electronic device to which energy is supplied by the fuel cell device can be adjusted in response to a secular output reduction of the cell stack 12 or the like.

Thus, there may be obtained a fuel cell device and a driving method therefor such that the fuel flow rate can be optimally controlled depending on operating conditions and that the output energy can be enhanced without increasing the methanol crossover rate.

The following is a description of a fuel cell device 10 according to a second embodiment. In the foregoing first embodiment, the liquid pump 30 and the cell control section 16 that controls the drive voltage of the liquid pump are used for the flow regulator section 36 that adjusts the fuel flow rate. If the adjustable range of the single liquid pump for the flow rate is narrow, however, a variable valve may be used in place of the liquid pump.

According to the second embodiment, as shown in FIG. 7, ancillary components provided at an anode channel 22 include a liquid pump 30 connected to the output portion of a mixing tank 28 and a variable valve 50 connected between the output portion of the liquid pump and a cell stack 12. The liquid pump 30 supplies an aqueous methanol solution from the mixing tank 28 to the anode 67 through the variable valve 50.

The mixing tank 28 is fitted with a liquid amount sensor 38 for detecting the amount of the aqueous methanol solution in the mixing tank. The sensor 38 is electrically connected to the cell control section 16. The liquid amount sensor 38 detects whether or not the liquid amount in the mixing tank 28 is inappropriate and outputs detection data to the cell control section 16. The liquid pump 30 is electrically connected to the cell control section 16. The drive voltage or rate of rotation of the pump 30 is controlled by the cell control section, whereby the flow rate of the fuel supplied to the anode 67 is adjusted. The variable valve 50 is electrically connected to the cell control section 16 so that the valve opening and the fuel flow rate can be controlled or adjusted by the cell control section. Thus, the liquid pump 30, variable valve 50, and cell control section 16 constitute a flow regulator section 36 for adjusting the fuel flow rate.

Other configurations of the fuel cell device 10 of the second embodiment are the same as those of the foregoing first embodiment, so that like reference numbers are used to designate like portions throughout the drawings, and a detailed description of those portions is omitted.

According to the fuel cell device of the second embodiment, the flow rate of the fuel supplied to the anode is appropriately controlled according to the amount of fuel in the mixing tank and the output energy of the cell stack 12. By doing this, the output energy can be enhanced without increasing the methanol crossover rate. Further, the adjustable range for the flow rate is widened by the use of the liquid pump and the variable valve, so that the fuel flow rate can be more optimally controlled depending on operating conditions.

While certain embodiments of the invention have been described, these embodiments have been presented by way of example only, and are not intended to limit the scope of the invention. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

The fuel cell device may also be built in the electronic device instead of being externally connected to the electronic device.

What is claimed is:

1. A fuel cell device comprising:
an electromotive module which comprises an anode and a cathode and is configured to generate electricity by a chemical reaction between a fuel supplied to the anode and air supplied to the cathode;
a tank configured to store the fuel;
a fuel channel on the anode side of the electromotive module configured to flow the fuel supplied from the tank;
a flow regulator configured to adjust a flow rate of the fuel supplied to the anode;
a sensor configured to detect an amount of the fuel in the tank; and
a cell controller configured to cause the flow regulator to adjust the fuel flow rate to an upper limit value when an increase in the amount of fuel in the tank is detected and to adjust the fuel flow rate to a minimum necessary flow rate for an electricity generation operation of the electromotive module when a decrease in the amount of fuel in the tank is detected, the increase and the decrease are computed as a change in the detected fuel amounts by the sensor.

2. The fuel cell device of claim 1, wherein the cell controller is configured to measure electrical power output of the electromotive module and to cause the flow regulator to increase the fuel flow rate so that the electrical power output is not smaller than a predetermined value [when the amount of fuel in the tank is found to be neither greater nor smaller than a predetermined value as a change in the detected fuel amount by the sensor, and is configured to cause the flow regulator to adjust the fuel flow rate to the upper limit value when the electrical power output is smaller than the predetermined value.

3. The fuel cell device of claim 1, wherein the flow regulator is situated at the fuel channel between the tank and the anode and is provided with a liquid pump having a flow rate varied according to a driving voltage, and the cell controller comprises means for adjusting the flow rate by changing the driving voltage of the liquid pump.

4. The fuel cell device of claim 1, wherein the flow regulator is situated at the fuel channel between the tank and the anode and is provided with a liquid pump having a flow rate varied according to a driving voltage, and a variable valve is situated at the fuel channel between the liquid pump and the anode and having an adjustable valve opening, and the cell controller comprises means for adjusting the fuel flow rate by changing the driving voltage of the liquid pump and the opening of the valve.

5. The fuel cell device of claim 1, which further comprises a gas channel having an intake port and an exhaust port and configured so that air drawn in through the intake port is circulated through the cathode and that an exhaust gas produced in the electromotive module is discharged through the exhaust port.

6. A method of driving a fuel cell device, which is provided with an electromotive module which comprises an anode and a cathode and is configured to generate electricity by a chemical reaction between a fuel supplied to the anode and air supplied to the cathode, a tank configured to store the fuel, a fuel channel on the anode side of the electromotive module configured to flow the fuel supplied from the tank, and a flow regulator configured to adjust a flow rate of the fuel supplied to the anode, the method comprising:
detecting an amount of the fuel in the tank;
causing the flow regulator to adjust the fuel flow rate to an upper limit value of an adjustable range when an increase in the amount of fuel in the tank is detected, as a change in the detected fuel amounts by the sensor;
causing the flow regulator to adjust the fuel flow rate to a minimum necessary flow rate for an electricity generation operation of the electromotive section when a decrease in the amount of fuel in the tank is detected as a change in the detected fuel amounts by the sensor;
measuring electrical power output of the electromotive module and causing the flow regulator to increase the fuel flow rate so that the electrical power output is not smaller than a predetermined value when the amount of fuel in the tank is found to be neither greater nor smaller than a predetermined value, as a change in the fuel amounts detected by the sensor; and
causing the flow regulator to adjust the fuel flow rate to the upper limit value of the adjustable range when the electrical power output is smaller than the predetermined value, based on the result of the measurement of the electrical power.
